(19) United States
(12) Patent Application Publication
(10) Pub. No.: US 2013/0246190 A1
(43) Pub. Date: Sep. 19, 2013

(54) ADVERTISEMENT PROVIDING SYSTEM AND METHOD FOR PROVIDING INTERFACE FOR INTEGRATED PAYMENT WITH REGARD TO GOODS IN INTEGRATED MARKETPLACE

(71) Applicant: NHN BUSINESS PLATFORM CORPORATION, Songnam-si (KR)

(72) Inventor: HyangCheol LEE, Seongnam-si (KR)

(73) Assignee: NHN Business Platform Corporation, Seongnam-si (KR)

(21) Appl. No.: 13/718,577

(22) Filed: Dec. 18, 2012

(30) Foreign Application Priority Data
Mar. 19, 2012 (KR) 10-2012-0027844

(51) Int. Cl. G06Q 30/06

(52) U.S. Cl. CPC G06Q 30/0641; G06Q 30/0277
USPC 705/14.69; 705/14.73

(57) ABSTRACT

Provided is a system and method for providing an advertisement that provides an interface for an integrated payment for products in an integrated e-marketplace. The system for providing the advertisement may include: an advertisement receiving unit to receive advertisements associated with products or services sold by a plurality of affiliate stores, an advertisement providing unit to provide at least a portion of the received advertisements to a user connected to a website, an information processing unit to store information on an advertisement selected by the user and providing the information on the advertisement, and an integrated payment processing unit to receive product information from the plurality of affiliate stores associated with the advertisements, and process an integrated payment with respect to products or services selected by the user.

### CROSS-REFERENCE TO RELATED APPLICATION

This application claims priority from and the benefit of Korean Patent Application No. 10-2012-0027844, filed on Mar. 19, 2012, which is hereby incorporated by reference for all purposes as if fully set forth herein.

### BACKGROUND OF THE INVENTION

1. Field of the Invention

Exemplary embodiments of the present invention relate to a system and method for providing an advertisement that provides an interface for an integrated payment for products in an integrated e-marketplace.

2. Description of Related Art

E-commerce or E-business may refer to business conducted between a vendor and a consumer via the Internet and the like. An E-marketplace is a mediator that connects a supplier and a consumer through media such as the Internet and the like. A key component of the E-marketplace is connecting the supplier and the consumer, independent of a wholesaler or supplier. A large portion of E-marketplace profits may result from transactions being completed. A portion of the E-marketplace may have a profit model that includes a registration fee and the like. A company may reduce its risk in conducting business with new or unidentified companies, with the reliability of the E-marketplace, and costs may be decreased as a process of purchasing goods is simplified through establishing a procurement system between the e-marketplace and companies.

FIG. 1 is a diagram illustrating a platform structure of an E-marketplace according to related art. According to the conventional art the E-marketplace may include a registering platform 110 to register information of goods for sale, a publishing platform 120 to publish information with respect to registered goods, and an affiliate platform 130 for an affiliate marketing scheme. The affiliate marketing scheme is a technique employed to increase traffic and sales by gathering an affiliate 140 such as, an e-commerce merchant site advertising a website of a consumer. For example, when a performance result is obtained through the affiliate site as in a pay-for-performance scheme, an advertising fee may be paid to the affiliate 140.

The registering platform 110 may be operated through an online auction site or an online shopping mall company such as, AUCTION or EBAY. The publishing platform 120 may be operated through a system that provides a personal webpage service, a café, a blog, a mini-homepage, or the like. The publishing platform 120 may be a reward website. The affiliate platform 130 may be operated by a company providing the affiliate marketing scheme. Each of the platforms of FIG. 1 is operated as a separate system in the related art.

According to the conventional art, E-marketplace may provide an interface for an integrated payment for a plurality of products selected by a user, similar to a shopping cart. However, the shopping cart functionality refers to processing an integrated payment for collected products of sellers provided by a single E-marketplace only, rather than processing an integrated payment for products of a plurality of or different E-marketplaces.

In FIG. 1, the payment service may include a check-out payment service. The check-out payment service allows users subscribing to a payment service, provided by a portal site, to purchase and pay for goods with an identification (ID) of the portal site. A payment for goods on a personal page where the goods are registered is conducted using the check-out payment service. The check-out payment service also supports a payment using reserved points or a voucher.

### SUMMARY OF THE INVENTION

Exemplary embodiments of the present invention provide a system and method for providing an advertisement to an integrated e-marketplace by processing a registration, a display, a sale, and a payment of goods integrally.

Exemplary embodiments of the present invention also provide a system and method for providing an advertisement that processes a registration, a display, a sale, and a payment of goods integrally.

Exemplary embodiments of the present invention also provide a system and method for providing an advertisement that enhances an advertising effect by providing a reward to a user working as an affiliate through an affiliate platform for an affiliate marketing scheme, as well as providing an integrated e-marketplace by processing a registration, a display, a sale, and a payment integrally.

Exemplary embodiments of the present invention also provide a system and method for providing an advertisement that processes a registration, a display, a sale, and a payment with respect to products integrally, and provides an interface to enable an integrated payment for products of different e-marketplaces.

Additional features of the invention will be set forth in the description which follows, and in part will be apparent from the description, or may be learned by practice of the invention.

Exemplary embodiments of the present invention disclose a system for providing an advertisement, the system including: a storage device; an advertisement receiving unit configured to receive advertisements associated with products or services sold by a plurality of affiliate stores, each affiliate store providing an e-marketplace; an advertisement providing unit configured to provide at least a portion of the received advertisements to a user connected to a website; an information processing unit configured to store information on an advertisement associated with the user in the storage device, and configured to provide the information on the advertisement associated with the user to the user through the website, in a response to a request from the user; and an integrated payment processing unit configured to receive product information from the plurality of affiliate stores associated with the associated advertisements, and configured to process an integrated payment for products or services selected by the user, based on the product information received from the plurality of affiliate stores.

Exemplary embodiments of the present invention disclose a method of providing an advertisement using a processor, the method including: receiving advertisements associated with products or services sold by a plurality of affiliate stores, each affiliate store providing an e-marketplace; providing at least a portion of the received advertisements to a user connected to a website; storing information on an advertisement associated with the user, and providing the information associated with the advertisement to the user through the website in a response to a request from the user, using the processor; and receiving product information from the plurality of affiliate stores associated with the associated advertisements, and processing an integrated payment for products or services selected by the user, based on the product information received from the plurality of affiliate stores.

Exemplary embodiments of the present invention disclose one or more non-transitory computer-readable storage media having stored thereon a computer program that, when executed by one or more processors, causes the one or more processors to perform acts that provide an advertisement including: receiving advertisements associated with products or services sold by a plurality of affiliate stores, each affiliate store providing an e-marketplaces; providing at least a portion of the received advertisements to a user connected to a website; storing in a storage device information on an advertisement associated with the user, and providing the information associated with the advertisement to the user through the website in a response to a request from the user; and receiving product information from the plurality of affiliate stores associated with the associated advertisements, and processing an integrated payment for the products or the services selected by the user, based on the product information received from the plurality of affiliate stores.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a platform structure of an e-marketplace according to related art.

FIG. 2 illustrates a portal site system and a system for providing an advertisement according to exemplary embodiments of the present invention.

FIG. 3 illustrates a method for providing an advertisement according to exemplary embodiments of the present invention.

FIG. 4 illustrates a process for exchanging information about goods through a social networking service according to exemplary embodiments of the present invention.

FIG. 5 illustrates a platform structure according to exemplary embodiments of the present invention.

FIG. 6 illustrates a relationship of a member, an affiliate store, and a system for providing an advertisement according to exemplary embodiments of the present invention.

FIG. 7 illustrates products of a plurality of affiliate stores selected by a user according to exemplary embodiments of the present invention.

FIG. 8 illustrates a real-time interfacing entry according to exemplary embodiments of the present invention.

FIG. 9 illustrates basic product information according to exemplary embodiments of the present invention.

FIG. 10 illustrates product option information and additional product information according to exemplary embodiments of the present invention.

FIG. 11 illustrates a detailed entry of a shipping charge policy for each of products and a bundle group policy according to exemplary embodiments of the present invention.

FIG. 12 illustrates a portion of a webpage providing detailed information of products selected by a user according to exemplary embodiments of the present invention.

FIG. 13 illustrates a portion of a knowledge shopping webpage according to exemplary embodiments of the present invention.

FIG. 14 illustrates an internal configuration of a system for providing an advertisement according to exemplary embodiments of the present invention.

FIG. 15 illustrates a method for providing an advertisement according to exemplary embodiments of the present invention.

### DETAILED DESCRIPTION OF THE ILLUSTRATED EMBODIMENTS

Exemplary embodiments of the present invention will be described in detail with reference to the accompanying drawings. These exemplary embodiments will be described in detail for those skilled in the art in order to practice the present invention. It should be appreciated that various exemplary embodiments of the present invention are different but do not have to be exclusive. For example, specific shapes, configurations, and characteristics described in an exemplary embodiment of the present invention may be implemented in another exemplary embodiment without departing from the spirit and the scope of the present invention. In addition, it should be understood that position and arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements and/or components, but do not preclude the presence or addition of one or more other features, integers, steps, operations, elements, components, and/or groups thereof.

Hereinafter, exemplary embodiments of the present invention are described in detail with reference to the accompanying drawings.

It will be understood that when an element is referred to as being “connected to” another element, it can be directly connected to the other element, or intervening elements may be present.

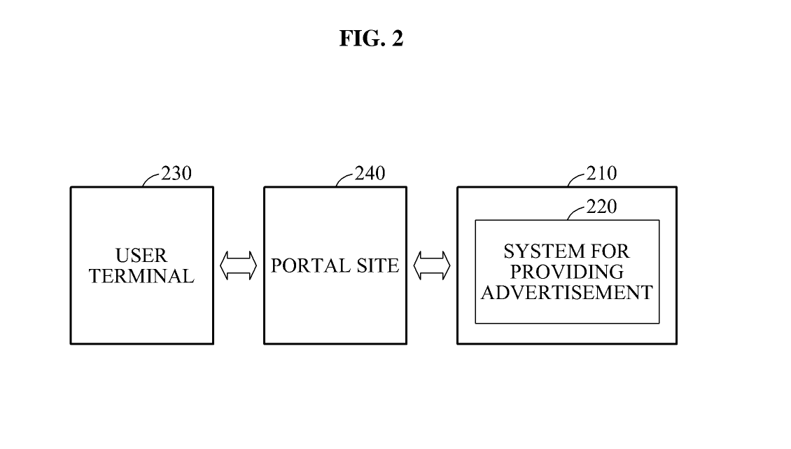

FIG. 2 illustrates a portal site system and a system for providing an advertisement 220 (advertisement system 220) according to exemplary embodiments of the present invention.

An advertisement system 220 is included in a portal site system 210. The portal site system 210 may provide a portal site 240. A user requesting access through a user terminal 230 can access the portal site 240 and obtain various services.

The various services provided to users through the portal site 240 may correspond to a shopping information providing service, a web document searching service, a personal page managing service, a social networking service, a payment service, and the like. The shopping information service may include a goods searching service for shopping. The web document searching service may include a service that provides specific webpages, for example, by conducting a search corresponding to a keyword. The personal page managing service may assign and manage a page of a specific uniform resource locator (URL) to a personal user subscribing as a member of a blog, a café, or a mini-homepage. A webpage for an advertisement search may be included in a webpage provided by the web document searching service. The social networking service may include a service that enables users on a web-site to form a human network. The social networking service may be combined with a personal web environment (PWE) or a personal page managing service.

The advertisement system 220 included in the portal site system 210 may be provided directly or be connected to a plurality of services including at least one of the shopping information providing service, the web document searching service, the personal page managing service, the social networking service, and the payment service. The advertisement system 220 may register goods through a personal page assigned to a user subscribing as a member and display information with respect to a registered personal page or registered goods using at least one of the various aforementioned services to users.

For example, the portal site 240 and the various services provided by the portal site 240 may be utilized for the integrated e-marketplace via the advertisement system 220.

When the registered personal page or the registered goods information is uploaded through the social networking service and a purchase of goods occurs through the uploaded information, the advertisement system 220 may provide a reward to a user uploading the information. For example, the advertisement system 220 may include an affiliate platform for an affiliate marketing scheme. In this example, a main publisher of the affiliate marketing scheme may utilize the various services provided by the portal site 240.

For example, given a service A is provided by either the advertisement system 220 or the portal site system 210, and information about goods are either registered on a personal page B of a user b or on a personal page B that registers the goods as having been uploaded by a user c through service A, when a user d purchases the goods by visiting the personal page B, a reward may be provided to the user c who had uploaded the information.

The social networking service may be utilized in conjunction with the personal page managing service. The purchase of the goods may be conducted through the personal page on which the goods are registered for a first time. The information uploaded through the social networking service may include a link to the personal page on which the goods are registered for the first time. In the example described above, the user c makes a clipping of, more particularly, uploads, the goods information registered onto personal page B of the user b to a personal page C of the user c. Here, a link to the personal page B may be set in the uploaded goods information. In this instance, when a user d visiting the personal page C purchases the goods through the link to personal page B, the advertisement system 220 may provide the reward to the user c.

The reward may be provided in a form of reward points and the like. The points are managed by the portal site system 210, or provided only to users uploading information through the social networking service or the personal page for a first time when necessary. As used herein, the “reward points” may be a unit of a real-world value. In some embodiments, reward points may be represented as cyber money, for example, points or mileage corresponding to moneys in the real-world. For example, when necessary, the cyber money may be represented as cyber money exchangeable at, for example, a 1:1 ratio, 1:10 ration, or the like.

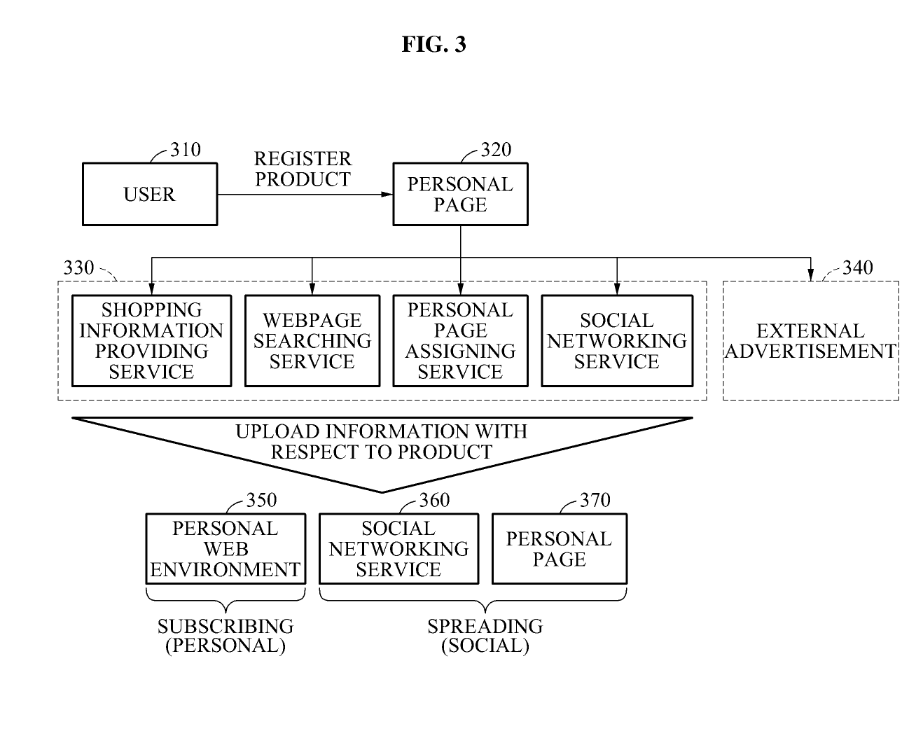

FIG. 3 illustrates a method for providing an advertisement according to exemplary embodiments of the present invention. A user 310 may register goods through a personal page 320 assigned to the user 310. An advertisement system may display information about goods or a personal page 320 through various services 330. For example, the advertisement system may display the information using a shopping information providing service when searching for goods, or the advertisement system may display the information by including the information in a result found through a web document searching service. The advertisement system may display information through a café, a blog, a mini-homepage, and the like, using a personal page managing service, or display the information through a social networking service. The advertisement system may display the information through an external advertisement 340. The “external advertisement” 340 may indicate another portal site or another publisher.

A “publisher” may be referred to as a “site”. However, the term “site” is not to be construed as excluding an executable an unusual website connection, such as an application screen implemented in a mobile terminal, and the like). The “site” may be compatible with a “publishing site” or the “publisher”. As an example, each site may correspond to an individual publisher. The “site” may include a type of website through which an advertisement may be displayed. The site may be provided via a wired or wireless network to a user. The site may comprise a single webpage configuring a website. “Displaying” information of an advertisement, goods, and the like, may be interpreted as providing promotional content, such as, a text, an image, a sound, a video, a hyperlink, and the like, to a visitor of a corresponding site associated with an advertiser through the site or the publisher. Further, a “selection” the displayed advertisement may indicate an occurrence of a situation which the advertiser intends to deliver the promotional content, by displaying promotional content, such as, the provided text, the image, and the like. For example, the advertisement may include a situation in which a page associated with the advertiser is displayed to a user selecting an advertisement.

Other users may subscribe to the displayed information. For example, information may be provided to users applying for a subscription to the displayed information through a personal web environment (PWE) 350 to a personal space of the users, and the users may verify the provided information in the personal space readily. The personal space may provide a personal web storage space and may support a housekeeping book service, a calendar service, or a schedule management. The users may verify the information provided to the personal webpage when a wired or wireless Internet connection is available. Information being subscribed to may be provided to the personal space periodically or when the information corresponds to a set condition.

The displayed information may be uploaded or spread through the social networking service 360 or the personal page 370. For example, information once displayed by the user may be displayed to other users secondarily by the other users. The advertisement system may provide the reward to users uploading the information.

Although the social networking service 360 and the personal page 370 are illustrated separately in FIG. 3, a blog, a café, a mini-homepage, and the like, may be included in the social networking service 360 to form a personal relationship with other users. Uploading information with respect to goods through the social networking service 360 may include delivering the information through e-mail.

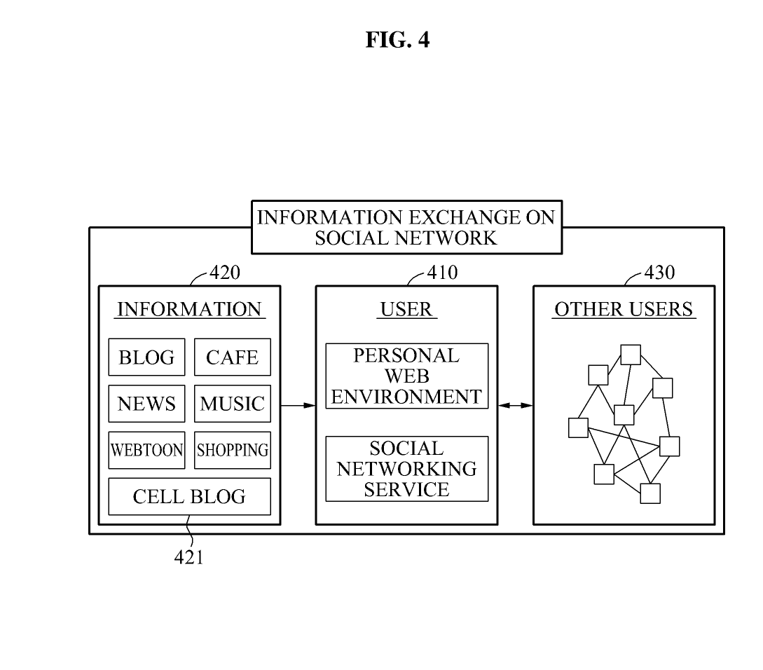

FIG. 4 illustrates a process of exchanging information about goods through a social networking service according to exemplary embodiments of the present invention.

A user 410 may subscribe to information 420 about goods, information that is displayed through various services, for example, PWE, or upload the information 420 through a social networking service. The information 420 may be displayed via a variety of means such as a blog, a café, news, a webtoon, shopping, and the like. A cell blog 421 may indicate a personal page on which the information 420 is registered. Information being subscribed to by the user 410 via the PWE may be uploaded through the social networking service by the user 410. The information being subscribed to by the user 410 via the PWE may be uploaded through the social networking service automatically, based on a selection of the user 410. The information 420 uploaded through the social networking service may be displayed to other users 430 forming a personal relationship with the user 410. When at least one of other users 430 purchases goods from a display including the information 420, a reward may be provided to the user 410. Purchasing of the goods may be restricted to a purchase occurring in the cell blog 421. In this instance, the user 410 may work as an affiliate in an integrated e-marketplace without a subscription to a membership.

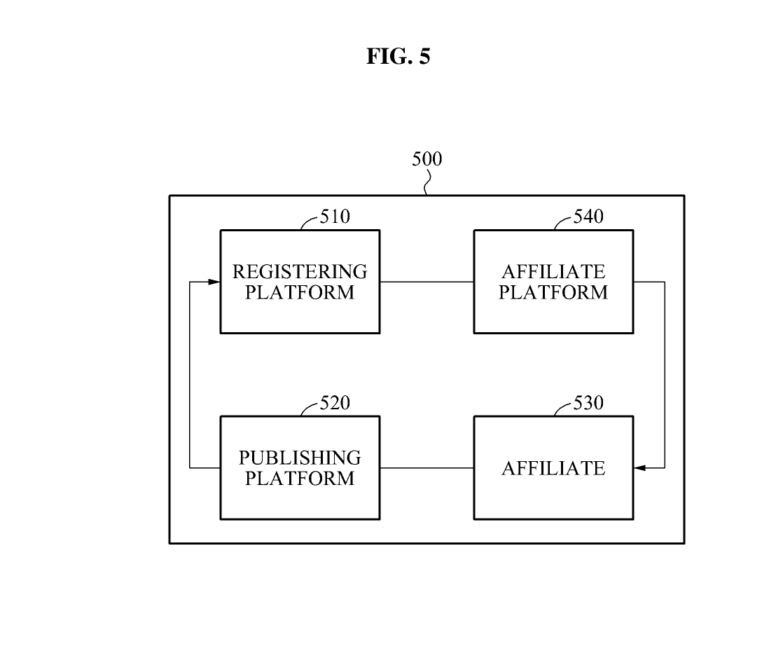

FIG. 5 illustrates a platform structure according to exemplary embodiments of the present invention. The present invention provides an integrated system 500 including a registering platform 510 to register information about the goods and services for sale, a publishing platform 520 to publish information about the registered goods, and an affiliate platform 540 to manage a performance of an affiliate 530 and distribute profit. A process of registering, displaying, selling, processing payment for, and distributing of the profits of the goods may be conducted integrally through the single system. The integrated e-marketplace 500 may be provided using the various services provided by a single portal site.

The registering platform 510 may manage detailed information of goods registered through a cell blog. The registering platform 510 may manage a trending interest or purchase reviews submitted by users with respect to the goods. The registering platform 510 may receive and manage an input of information about an event or a promotion, and display the information about the event or the promotion through the cell blog.

The publishing platform 520 may be utilized in conjunction with a social networking service to promote information about the goods secondarily, for example, through a buzz marketing scheme or a viral marketing scheme, as well as a direct advertisement of goods using a blog, a café, a mini-homepage, an e-mail, and the like. The publishing platform 520 may provide traffic to the cell blog by displaying information about the goods or the cell blog through the blog, the café, the mini-homepage, e-mail, or the social networking service. The publishing platform 520 may be able to provide an advertisement that encourages goods to be purchased by attracting the users to the cell blog.

The affiliate 530 may be a member of the portal site system 210 described in FIG. 2. Affiliate 530 may be restricted, when necessary, to members of a check-out payment service provided by the portal site system 210.

The affiliate platform 540 may distribute profits by managing a performance of the affiliate 530. A reward such as a reserved point or a voucher may be provided to the affiliate 530 to encourage the purchase of the goods by uploading the information with respect to the goods through the social networking service. The members of the payment service may be encouraged to promote the information about the goods secondarily to users by forming personal relationships spontaneously.

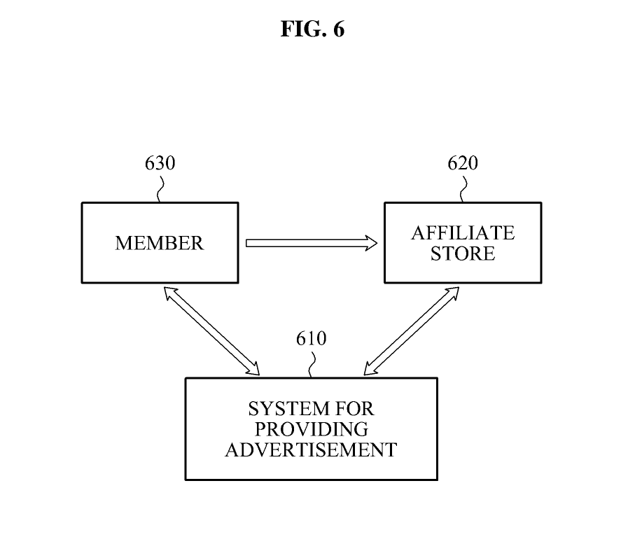

FIG. 6 illustrates a relationship of a member, an affiliate store, and an advertisement system according to exemplary embodiments of the present invention. In particular, FIG. 6 represents a relationship of the advertisement system 610, the affiliate store 620, and the member 630.

Here, the advertisement system 610 may refer to a portal site system that provides various services to users through a portal site or a system included in the portal site system as described above. Also, the affiliate store 620 may indicate an advertiser site via which subscription to an affiliate store is requested and an authorization of the subscription among advertisers displaying an advertisement through the portal site is completed. Further, the member 630 may refer to a user subscribing to the portal site as a member. For example, the portal site system may display an advertisement associated with the affiliate stores 620 or an advertisement associated with products or services being sold by the affiliate store 620, through the portal site to the member 630.

Here, although the member 630 may visit the affiliate store 620 through the advertisement associated with the affiliate store 620, the member 630 may purchase the products or services, hereinafter referred to as “products”, being sold by the affiliate store 620 directly. The advertisement system 610 may provide an integrated e-marketplace through the portal site, and thereby sell products or services of the affiliate store 620 directly, through the portal site.

In this instance, the member 630 may request that a purchase of a product or a service be displayed through the portal site, using a user interface such as a purchase button. The advertisement system 610 may receive a portion of product information necessary for an order from a corresponding affiliate store 620 to process order information. For example, the affiliate store 620 may calculate an amount ordered, a shipping charge, and the like, and transmit a final price to the advertisement system 610.

When the member 630 intends to purchase a plurality of products or services sold by a plurality of different affiliate stores, the advertisement system 610 may need to calculate and process a payment for the plurality of products or services to be purchased by the member 630 integrally. For example, when the order information is processed only in an occurrence of an order, a real-time update about product information selected by the user and stored in the shopping cart fails to be performed, and as a final price is delivered by the affiliate store 620, the advertisement system 610 may be unable to understand a logic of a payment generated. In addition, as each of the plurality of affiliate stores proceeds with payment through a Payment Gateway (PG) possibly under separate contracts with each of the affiliate stores, each with differing terms, placing simultaneous orders with respect to a plurality of affiliate stores may be complicated. Also, providing for various sales, marketing, or service activities, such as, charging a fee through handling of an accounting amount, may be difficult.

The advertisement system 610 may receive product information through a real-time interface using an external product database and an application programming interface (API) for product information of the affiliate store 620. The advertisement system 610 may store the product information internally and update the product information in real time, aside from receiving the product information or a final price only when a request for purchasing products is received. The advertisement system 610 may calculate a payment integrally using entries for calculating a final price such as a shipping charge, a bundle product policy, and the like, and a calculation logic self-imposed through logic internalization.

Moreover, the advertisement system 610 may process an integrated payment without the PG at payment using an integrated shopping cart, by using a prepaid amount such as a checkout payment or cyber money; the integrated payment may be processed with the PG at a later time. A payment scheme may charge a predetermined amount through various payment means such as a credit card, a real-time account transfer, mobile phone payment and the like. Such a payment scheme may enable an integrated payment even when the checkout payment is not supported by the affiliate store 620.

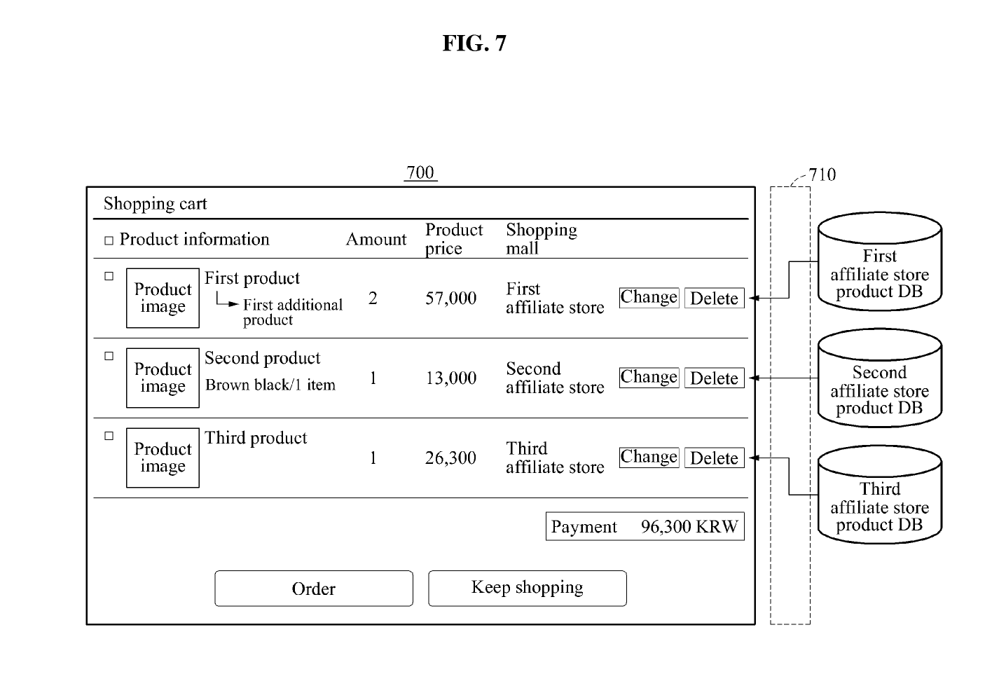

FIG. 7 illustrates products of a plurality of affiliate stores selected by a user according to exemplary embodiments of the present invention.

A webpage 700 may include a portion of a webpage providing an integrated shopping cart function for an integrated payment for products in an integrated e-marketplace. Here, the webpage 700 may be one of a plurality of webpages included in a portal site. As shown in the webpage 700, each of products selected by the user may be from different affiliate stores.

The advertisement system 610 of FIG. 6 may receive product information through a real-time interfacing process 710 from a product database for each of the plurality of affiliate stores. The advertisement system 610 may update the received product information with respect to products stored in a shopping cart. The advertisement system 610 may calculate a total price of a plurality of products directly to represent the total price. The advertisement system 610 may calculate the integrated payment for the plurality of products selected, using an amount such as a checkout payment or cyber money associated with affiliate stores.

When loading the integrated shopping cart, the advertisement system 610 may request product information from corresponding affiliate stores, and each of the corresponding affiliate stores may transmit detailed product information to the advertisement system 610. Here, the advertisement system 610 may update the integrated shopping cart, based on the detailed product information transmitted.

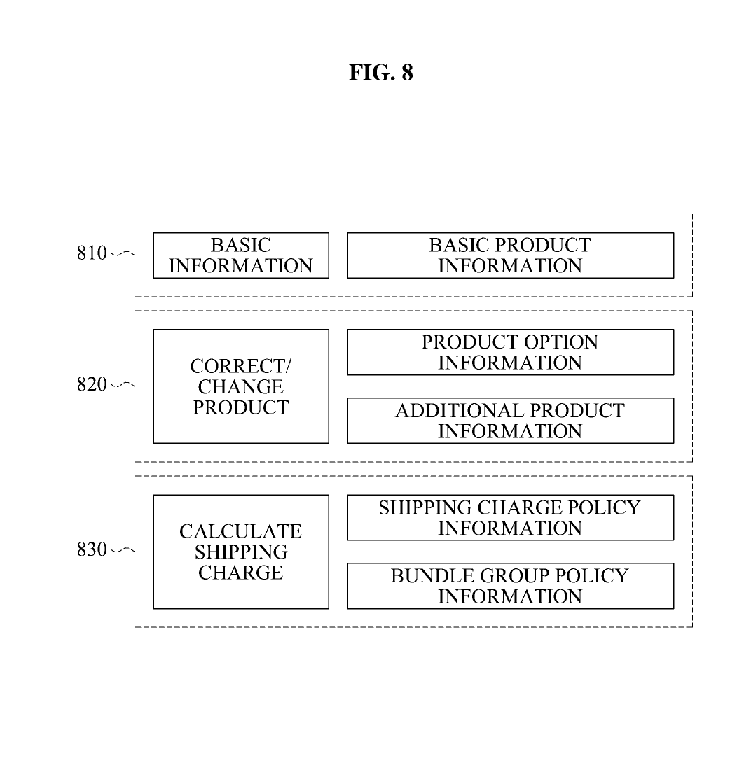

FIG. 8 illustrates a real-time interfacing entry according to exemplary embodiments of the present invention.

FIG. 8 illustrates entries for real-time interfacing with a database of affiliate stores for an integrated shopping cart operation such as ordering, changing an option, adding products, calculating a shipping charge, and the like. A first entry 810 may provide basic information for correcting/changing products. A second entry 820 may provide product option information and information for selecting a color, a size, and the like. Further, a third entry 830 may provide information for calculating a shipping charge, for example, shipping charge policy information and bundle group policy information.

Table 1 illustrates a first entry 810 providing the basic product information.

TABLE 1

| Entry | Content |
|---|---|
| Product classification KEY | Unique identifier of product - Classification KEY for |
| | operating DB |
| Product knowledge shopping ID | Identifier of knowledge shopping affiliated store when |
| | product is knowledge shopping registered product (mall_pid) |
| Name of product | Name of product |
| Selling price | Selling price of product |
| Order number | Number of products ordered |
| Stock check/number | Stock check/number of product |
| Shipping charge policy number | Shipping charge policy number of product - Classification |
| | KEY for operating DB |
| Bundle group policy number | Bundle group policy number when product has bundle group |
| | policy - Classification KEY for operating DB |
| Option classification KEY | Unique identifier of product option - Classification KEY for |
| | operating DB |
| Name of product option | Name of product option |
| Selling price of option | Selling price of product option |
| Number of option ordered | Number of product option ordered |
| Stock check for option | Stock check for product option |
| Additional product | Unique identifier of additional product - Classification KEY |
| classification KEY | for operating DB |
| Name of additional product | Name of additional product |
| Selling price of additional | Selling price of additional product |
| products | |
| Number of additional products | Number of additional products ordered |
| ordered | |
| Stock check for additional | Stock check for additional product |
| products | |

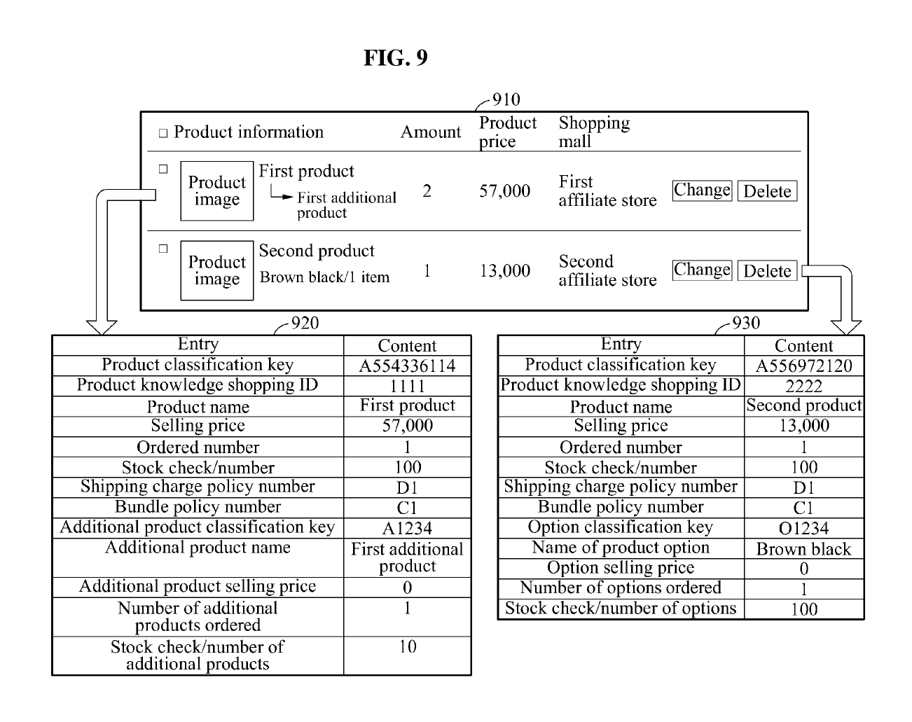

FIG. 9 illustrates basic product information according to exemplary embodiments of the present invention.

A webpage 910 may provide an integrated shopping cart function for an integrated payment for products in an integrated e-marketplace. A first table 920 may indicate basic product information on a first product displayed on the webpage 910, and a second table 930 may indicate basic product information on a second product displayed on the webpage 910.

Table 2 illustrates an exemplary database entry for a detailed configuration of product option information.

TABLE 2

| Entry | Content |
|---|---|
| Option classification | Unique identifier of option - Classification KEY for |
| KEY | operating DB |
| Option classification | Option classification: Single/combined/self-entry |
| Option label | Name of option |
| Name of option | Option name of option |
| Price of option | Additional charge for option |
| Stock check/number | Stock check and number of option |

Table 3 illustrates an exemplary database entry for a detailed configuration of additional product information.

TABLE 3

| Entry | Content |
|---|---|
| Additional component product | Unique identifier of corresponding |
| classification KEY | additional component product - |
| | Classification KEY for operating DB |
| Number of additional component | Number of corresponding additional |
| product | component products |
| Label of additional component | Label of corresponding additional |
| product | component product |
| Name of additional component | Name of corresponding additional |
| product | component product |
| Selling price of additional | Selling price of corresponding |
| component product | additional component product |
| Stock check/number | Stock check/number of corresponding |
| | additional component product |

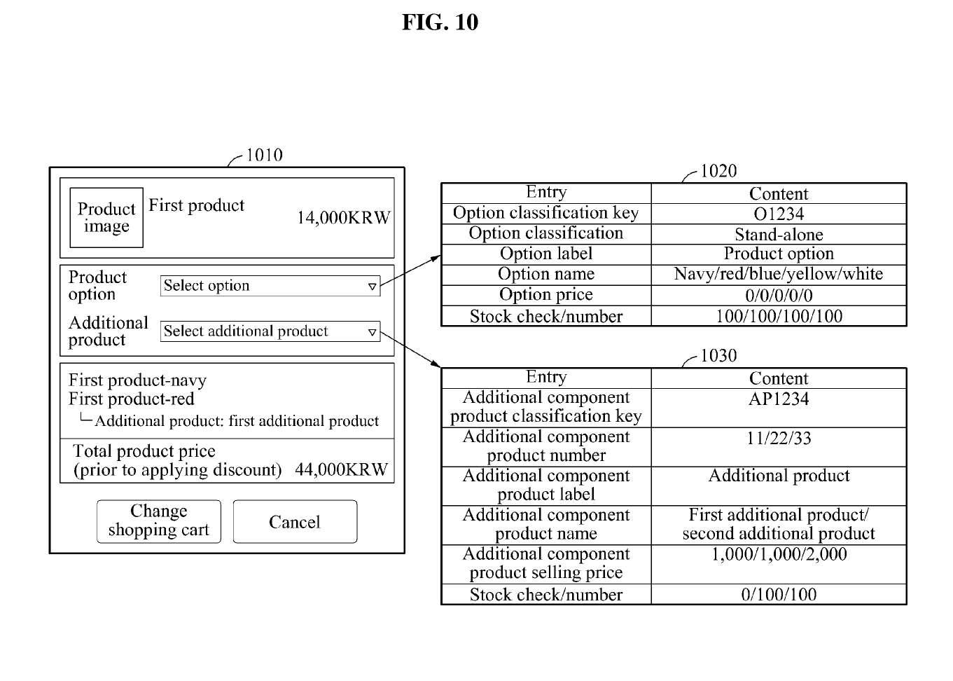

FIG. 10 illustrates product option information and additional product information according to exemplary embodiments of the present invention.

A webpage 1010 may provide an integrated shopping cart function for an integrated payment for products in an integrated e-marketplace. A first table 1020 may indicate basic database entries required for selecting a product option for a first product displayed in the webpage 1010, and a second table 1030 may indicate database entries required for selecting an additional product related to the first product displayed in webpage 1010.

Table 4 illustrates an example of information on a shipping charge related policy and a bundle group policy.

TABLE 4

| Entry | Content |
|---|---|
| Shipping charge | Shipping charge policy for each product |
| policy for each | Set shipping charge type, payment method (payment |
| product | upon delivery/pre-pay), bundle option, bundle |
| | group number, island/mountain area charge, |
| | and the like |
| Bundle | Policy of re-calculating total shipping charge based |
| group policy | on shipping charge for each product according |
| | to policy of corresponding group when each product |
| | is in specific bundle group |

The bundle group policy may include information on a shipping charge set for a bundle purchase of a plurality of products. The shipping charge for each product may be determined based on a database entry. However, in a case of the bundle group policy, a total shipping charge may be determined in various manners per the bundle group policy. In particular, the advertisement system 610 illustrated in FIG. 6 may receive information on the shipping charge policy for each product being sold by affiliate stores and the bundle group policy, and calculate a shipping charge for a total number of products selected by a user based on the received information.

Tables 5 and 6 are examples of database entries required for receiving information on the shipping charge policy and the bundle group policy.

TABLE 5

| Entry | Content |
|---|---|
| Shipping charge | Unique identifier of corresponding shipping |
| policy | charge policy - Classification KEY for |
| | operating DB |
| Type of shipping | When unnecessary for updating subsequent to |
| charge | pre-selecting, remove corresponding entry and |
| | use a basic operation DB |
| Basic shipping charge | Basic shipping charge |
| Terms of conditional | Whether to use policy of conditional free |
| free use | use such as free shipping over a predetermined |
| | price (Unavailable for 0) |
| Whether to use | “Not used” or “charge for additional purchasing |
| shipping charge by | number” or “input range” |
| purchasing number | |
| Charge for | When charging for every purchasing |
| additional | number of X, input corresponding number of X |
| purchasing number | |
| Range of purchasing | Extra shipping charge policy when charge by |
| number and extra | range of purchasing number is selected. For |
| shipping charge | example, 2-10::1000//11-100 ::2000 (Extra 1,000 |
| | Korean Won (KRW) for a range of 2-10 items, |
| | extra 2,000 KRW for a range of |
| | 11-100 items) |
| Island/mountain | Policy of applying graded island/mountain |
| area charge policy | area charge for each region: Unavailable for 0. |
| | For example, 3000/5000 (3,000 KRW for Region |
| | 2, 5,000 KRW for Region 3) |

TABLE 6

| Entry | Content |
|---|---|
| Bundle group policy | Unique identifier of corresponding |
| number | bundle policy - Classification KEY |
| | for operating DB |
| Calculation method of | Maximum charge or minimum charge |
| bundle shipping charge | |
| Island/mountain area | Policy of applying graded island/mountain area |
| charge policy | charge for each region: Unavailable for 0. |
| | For example, 3000/5000 (3,000 KRW for Region |
| | 2, 5,000 KRW for Region 3) |

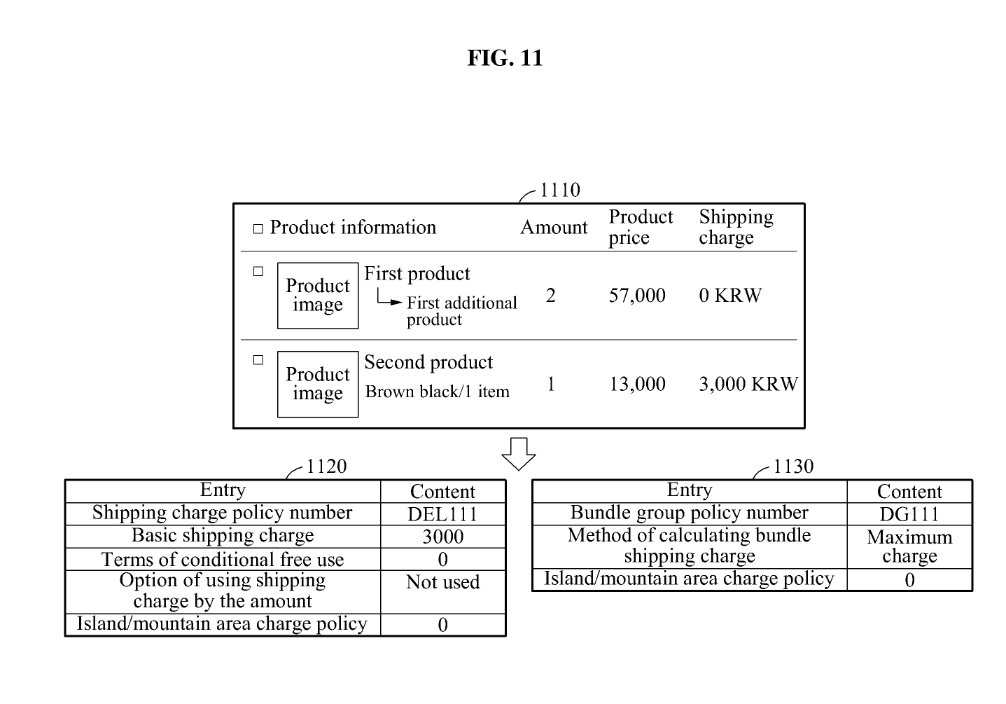

FIG. 11 is illustrates a detailed entry of a shipping charge policy for each of products and a bundle group policy according to exemplary embodiments of the present invention.

A webpage 1110 may indicate a portion of a webpage providing an integrated shopping cart function for an integrated payment for products in an integrated e-marketplace. A first table 1120 and a second table 1130 may indicate database entries required for calculating a shipping charge based on a shipping charge policy and a bundle group policy for each of second products displayed in the webpage 1110.

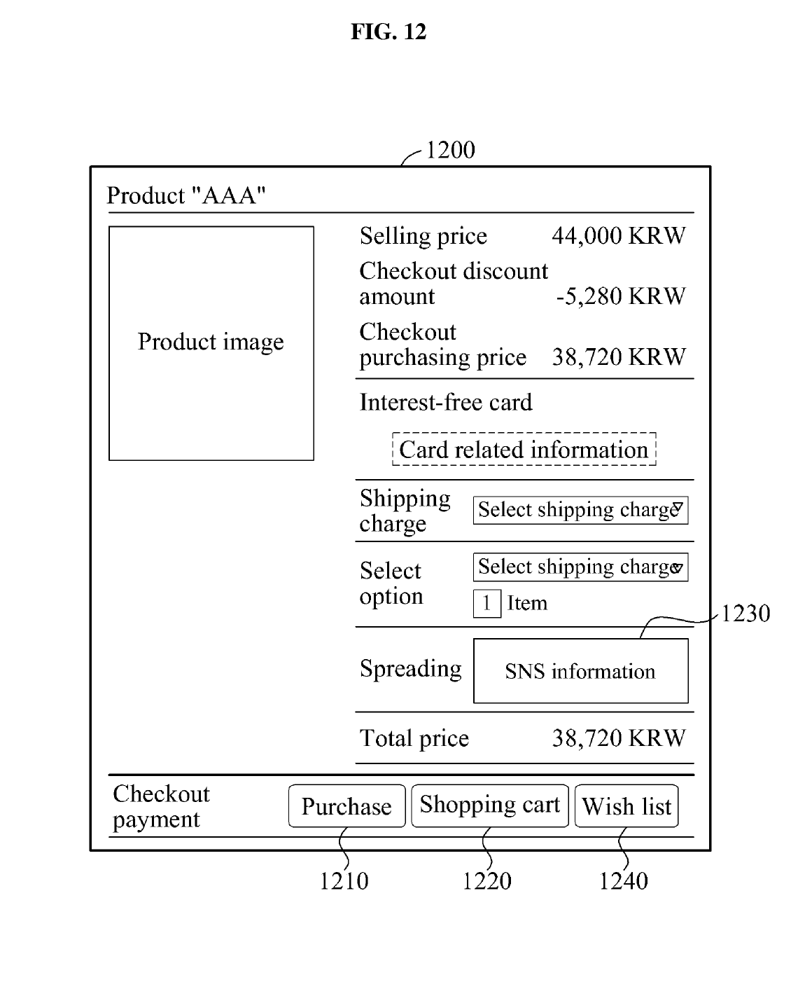

FIG. 12 illustrates a portion of a webpage providing detailed information of products selected by a user according to exemplary embodiments of the present invention.

A webpage 1200 may indicate a portion of a webpage including detailed information on a product “AAA”. The webpage 1200 may refer to a webpage of a corresponding affiliate store. For example, subsequent to an advertisement of the affiliate store being displayed to a user, when the user clicks on the displayed advertisement, the user may visit a website associated with the affiliate store or advertiser. A user interface for storing information on an integrated shopping cart provided by a portal site may be added to such a website.

In particular, the webpage 1200 illustrates a user interface “purchasing” 1210 for purchasing a product using a checkout payment and a user interface “shopping cart” 1220 for storing information on the product “AAA” in the integrated shopping cart. Here, when the user clicks on the user interface “shopping cart”, information on the product “AAA” may be stored in the integrated shopping cart. The user may select and store various products sold at a plurality of affiliate stores in the integrated shopping cart, and purchase a total number of the products selected in the integrated shopping cart at once. “Wish list” 1240 can store the product as a user selection for reminding later.

“SNS information” 1230 displayed on the webpage 1200 may indicate a user interface provided that allows the user to upload information on a product through a specific social networking service (SNS).

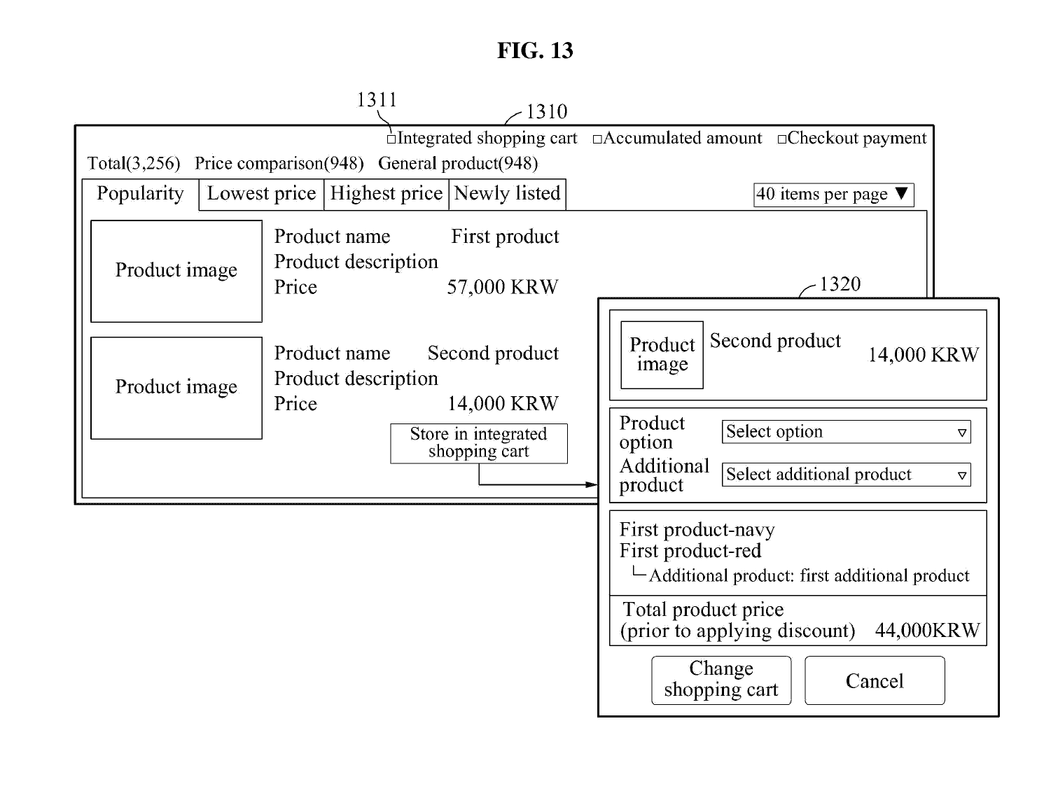

FIG. 13 illustrates a portion of a knowledge shopping webpage according to exemplary embodiments of the present invention.

A webpage 1310 may indicate a portion of a knowledge shopping page provided by a portal site. The webpage 1310, with respect to a product of affiliate stores using knowledge shopping, provides a user interface “integrated shopping cart” 1311 for a user to store information on a product associated with the user. Webpage 1310 may be displayed in association with a corresponding product. Here, FIG. 13 illustrates a pop-up window 1320 related to the corresponding product which is provided to the user when the user interface “integrated shopping cart” 1311 is selected by the user.

As shown in FIGS. 12 to 13, aside from a webpage in which an advertisement of an affiliate store is displayed in a portal site, a user interface for storing the information on the product in the integrated shopping cart may be displayed to the affiliate store. The user may be able to purchase various goods of a plurality of affiliate stores at once in the integrated e-marketplace using the user interface for the integrated shopping cart. Also, the user interface for the integrated shopping cart may be displayed on a webpage indicating whether a product is preselected by the user. The information on the product may be stored in the integrated shopping cart irrespective of a path via which the product is preselected by the user through the user interface for the integrated shopping cart.

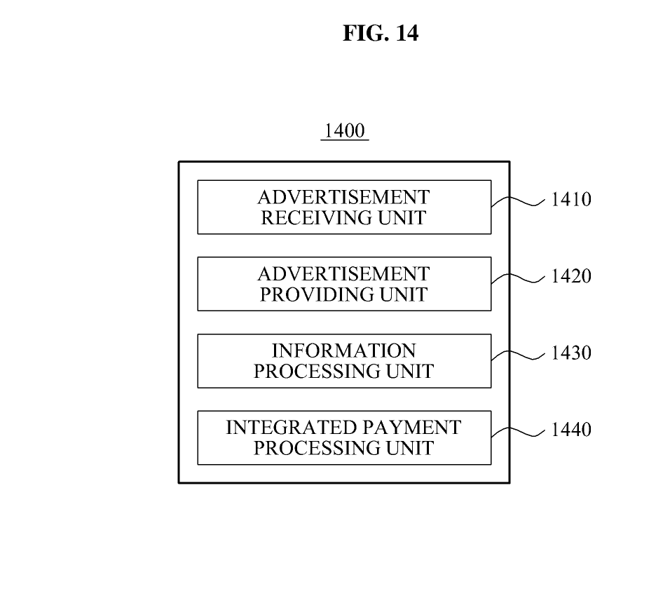

FIG. 14 illustrates an advertisement system 1400 according to exemplary embodiments of the present invention. The advertisement system 1400 may include an advertisement receiving unit 1410, an advertisement providing unit 1420, an information processing unit 1430, and an integrated payment processing unit 1440.

The advertisement receiving unit 1410 may receive advertisements associated with products or services sold by a plurality of affiliate stores providing e-marketplaces. The advertisements may be received from the plurality of affiliate stores directly, or received through a separate advertisement platform. The “advertisement platform” may include a system for performing bidding on an advertisement of an advertiser, matched to an advertisement and a keyword, aligning of advertisements or advertisers, providing an advertisement as a publisher, and charging for displaying of an advertisement, and the like. With respect to general technical aspects of an advertisement platform, descriptions of aspects construable with reference to related technology of a search advertisement and/or a banner advertisement platform delivered through the Internet is omitted. The received advertisements may be displayed through a website, and an advertisement fee involved in displaying an advertisement may be charged to affiliate stores. When an advertisement is received through the advertisement platform directly, charging involved in displaying the advertisement may be processed in the advertisement platform, and when an advertisement is received from affiliate stores directly, charging involved in displaying the advertisement may be executed by the advertisement system 1400 or the portal site system associated with the advertisement system 1400.

The advertisement providing unit 1420 may provide at least one portion of the received advertisements to a website. The website connected by the user may be a portal site or a website associated with the portal site, and the at least one portion of the received advertisements may be displayed through the website and provided to the user. Here, the at least one portion of the received advertisements may be displayed through the aforementioned portal site system.

The information processing unit 1430 may store information on an advertisement selected by a user in an integrated shopping cart associated with the user, and provide the information on the advertisement stored in the shopping cart associated with the user, in a response to a request. In this case, storing and providing the information on the advertisement may be processed through the function of the integrated shopping cart. In particular, when product information to be stored by the user in the shopping cart is selected, information on a corresponding product may be stored in the integrated shopping cart associated with the user, and the information on the product stored in the integrated shopping cart in the response to the request may be provided to the user once again.

The integrated payment processing unit 1440 may receive product information from affiliate stores associated with advertisements (based on information associated with advertisements stored in the integrated shopping cart associated with a user) and process an integrated payment for products or services selected by the user from the affiliate stores. A fee involved in the integrated payment may be charged to a corresponding affiliate store. As an example, aside from an advertisement fee involved in displaying an advertisement, sales may be increased through earnings related to processing the integrated payment.

The integrated payment processing unit 1440 may process a transaction charge for products or services selected by a user using at least one of a checkout payment using a user identifier issued to the user and a prepaid amount charged by the user.

Product information may include at least one of a unique identifier with respect to a corresponding product or service, a shipping charge policy number for identifying a shipping charge policy, and a bundle group policy number for identifying a bundle group policy with respect to a corresponding group when a corresponding product or service is included in a group of a plurality of products or services. The basic product information is described in detail with reference to Table 1 and FIG. 9. The integrated payment processing unit 1440 may calculate a payment to be charged for products or services selected by the user using a unique identifier and at least one of the shipping charge policy and the bundle group policy.

The product information may include at least a unique identifier for identifying a product option information when an option is selected by the user with respect to a product or a service. The product information may include a unique identifier for identifying additional product information when an additional product is selected by the user with respect to a product or a service.

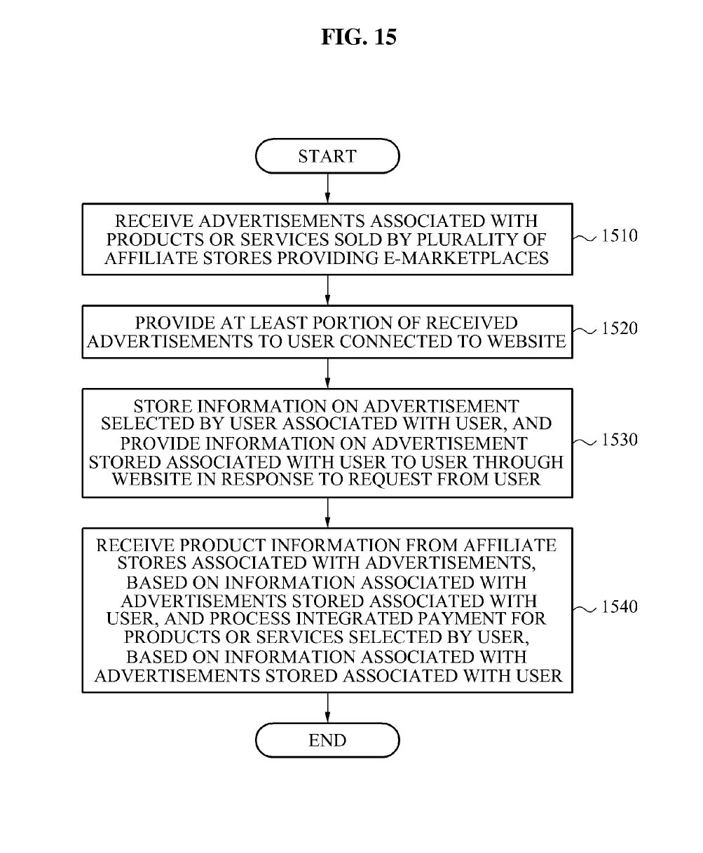

FIG. 15 illustrates a method for providing an advertisement according to exemplary embodiments of the present invention. The method for providing the advertisement may be conducted by, for example, the advertisement system illustrated in FIG. 14.

In step 1510, the advertisement system 1400 may receive advertisements associated with products or services sold by a plurality of affiliate stores providing e-marketplaces. The advertisements may be received from the plurality of affiliate stores directly, or received through a separate advertisement platform. The “advertisement platform” may indicate a system for performing bidding on an advertisement of an advertiser, matched to an advertisement and a keyword, aligning of an advertisement or an advertiser, providing an advertisement as a publisher, charging involved in displaying an advertisement, and the like. With respect to general technical aspects of the advertisement platform, descriptions construable with reference to conventional technology of a search advertisement and/or a banner advertisement platform provided via the Internet will be omitted as they are well known in the art. The received advertisements may be displayed through a website, and an advertisement fee involved in displaying an advertisement may be charged to affiliate stores. When an advertisement is received through the advertisement platform directly, charging involved in displaying the advertisement may be processed in the advertisement platform, and when an advertisement is received from affiliate stores directly, charging involved in displaying an advertisement may be executed by the advertisement system 1400 or the portal site system associated with the advertisement system 1400.

In step 1520, the advertisement system 1400 may provide at least one portion of the received advertisements to a user connected to a website. The “website connected by the user” may refer to a portal site or a website associated with the portal site. At least one portion of advertisements may be displayed through the website and provided to the user. Here, the at least one portion of advertisements may be displayed to the user through the portal site system.

In step 1530, the advertisement system 1400 may store information on a storage device for an advertisement selected by a user in an integrated shopping cart associated with the user, and the advertisement system 1400 may provide the information on the advertisement stored in the integrated shopping cart associated with the user to the user. The storing and providing of the information for the advertisement may be processed through the integrated shopping cart. When product information to be stored by the user in the shopping cart is selected by the user, information on a corresponding product may be stored in the integrated shopping cart associated with the user. The information on the product stored in the integrated shopping cart in the response to the request from the user may be provided to the user.

In step 1540, the advertisement system 1400 may receive product information from affiliate stores associated with advertisements, based on information associated with advertisements stored in the integrated shopping cart associated with a user, and process an integrated payment for products or services selected by the user, based on the product information received from the affiliate stores. A fee involved in the integrated payment may be charged to a corresponding affiliate store. As an example, in a medium displaying an advertisement, sales may be increased through additional earnings involved in processing the integrated payment, aside from an advertisement fee involved in displaying an advertisement.

The advertisement system 1400 may process an integrated payment for a transaction charge for products or services selected by the user using at least one of a checkout payment using a user identifier issued to the user and a prepaid amount charged to the user.

Product information may include at least one of a unique identifier with respect to a corresponding product or service, a shipping charge policy number for identifying a shipping charge policy, and a bundle group policy number for identifying a bundle group policy with respect to a corresponding group when a corresponding product or service is included in a group of a plurality of products or services. The basic product information is described in detail with reference to Table 1 and FIG. 9. The integrated payment processing unit 1440 may calculate a payment to be charged for products or services selected by the user, using a unique identifier with respect to products or services and using at least one of the shipping charge policy and the bundle group policy.

The product information may include at least a unique identifier for identifying a product option information when an option is selected by the user with respect to a product or a service. The product information may include at least a unique identifier for identifying additional product information when an additional product is selected by the user with respect to a product or a service.

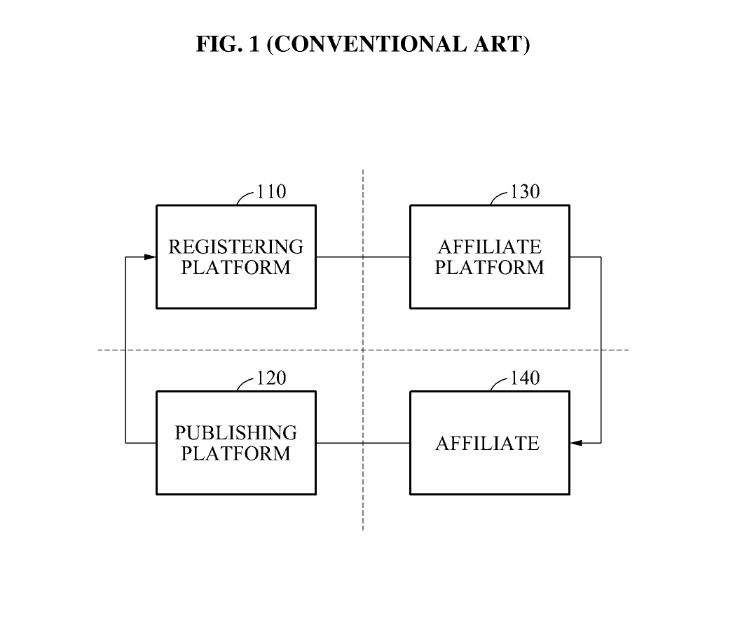

For any descriptions omitted in FIGS. 14 and 15, reference may be made to FIGS. 1 to 13.

According to exemplary embodiments of the present invention, an integrated e-marketplace may be provided by processing a registration, a display, a sale, and a payment for a product integrally. The registration, the display, the sale, and the payment of the product may be processed integrally by utilizing services provided by a portal site system that operates a portal site. An advertising effect may be enhanced by providing the integrated e-marketplace that processes the registration, the display, the sale, and the payment of the product integrally, and by providing a predetermined reward to a member working as an affiliate through an affiliate platform for an affiliate marketing scheme. An interface may be provided in which a registration, a display, a sale, and a payment with respect to products in a plurality of e-marketplaces may be processed integrally, and an integrated payment for products in different e-marketplaces may be possible.

According to exemplary embodiments of the present invention, it is possible to provide an integrated e-marketplace by processing a registration, a display, a sale, and a payment of goods integrally.

According to exemplary embodiments of the present invention, it is possible to process a registration, a display, a sale, and process a payment for goods integrally by utilizing services provided by a portal site system operating a portal site.

According to exemplary embodiments of the present invention, it is possible to increase an advertising effect by providing a predetermined reward to a user working as an affiliate through an affiliate platform for an affiliate marketing, as well as providing an integrated e-marketplace by processing a registration, a display, and a payment of goods integrally.

According to exemplary embodiments of the present invention, it is possible to provide an interface that processes a registration, a display, a purchase, and a payment for products of a plurality of e-marketplaces integrally, and enable an integrated payment for products of different e-marketplaces.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for providing an advertisement, the system comprising:
a storage device;
an advertisement receiving unit configured to receive advertisements associated with products or services sold by a plurality of affiliate stores, each affiliate store providing an e-marketplace;
an advertisement providing unit configured to provide at least a portion of the received advertisements to a user connected to a website;
an information processing unit configured to store information on an advertisement associated with the user in the storage device, and configured to provide the information on the advertisement associated with the user to the user through the website, in a response to a request from the user; and
an integrated payment processing unit configured to receive product information from the plurality of affiliate stores associated with the associated advertisements, and configured to process an integrated payment for products or services selected by the user, based on the product information received from the plurality of affiliate stores.

2. The system of claim 1, wherein the integrated payment comprises a transaction charge for the products or services selected by the user, using at least one of a checkout payment and a prepaid amount.

3. The system of claim 1, wherein for the products or the services selected by the user, the product information comprises at least one of a unique identifier corresponding to a selected product or service, a shipping charge policy identifier, and a bundle group policy identifier when the corresponding product or service is present in a group of a plurality of products or services.

4. The system of claim 3, wherein the integrated payment processing unit calculates a payment to be charged for the products or the services selected by the user, by using the unique identifier and at least one of the shipping charge policy identifier and the bundle group policy identifier.

5. The system of claim 1, wherein the product information comprises at least a unique identifier for identifying an option selected by the user.

6. The system of claim 1, wherein the product information comprises at least a unique identifier for identifying an additional product selected by the user.

7. The system of claim 1, wherein the integrated payment comprises a fee charged to a corresponding affiliate store.

8. A method of providing an advertisement using a processor, the method comprising:
receiving advertisements associated with products or services sold by a plurality of affiliate stores, each affiliate store providing an e-marketplace;
providing at least a portion of the received advertisements to a user connected to a website;
storing information on a storage device for an advertisement associated with the user, and providing the information associated with the advertisement to the user through the website in a response to a request from the user, using the processor; and
receiving product information from the plurality of affiliate stores associated with the associated advertisements, and processing an integrated payment for products or services selected by the user, based on the product information received from the plurality of affiliate stores.

9. The method of claim 8, wherein the processing of the integrated payment comprises:
processing a transaction charge for the products or the services selected by the user, using at least one of a checkout payment and a prepaid amount.

10. The method of claim 8, wherein for the products or the services selected by the user, the product information comprises at least one of:
a unique identifier corresponding to a selected product or service, a shipping charge policy identifier, and a bundle group policy identifier when the corresponding product or service is present in a group of a plurality of products or services.

11. The method of claim 10, wherein the processing of the integrated payment comprises:
calculating a payment to be charged for the products or the services selected by the user, by using the unique identifier and at least one of the shipping charge policy identifier and the bundle group policy identifier.

12. The method of claim 8, wherein the product information comprises at least:
a unique identifier for identifying an option selected by the user.

13. The method of claim 8, wherein the product information comprises at least:
a unique identifier for identifying an additional product selected by the user.

14. The method of claim 8, wherein the integrated payment comprises a fee charged to a corresponding affiliate store.

15. One or more non-transitory computer-readable storage media having stored thereon a computer program that, when executed by one or more processors, causes the one or more processors to perform acts that provide an advertisement, the acts comprising:
receiving advertisements associated with products or services sold by a plurality of affiliate stores, each affiliate store providing an e-marketplace;
providing at least a portion of the received advertisements to a user connected to a website;
storing in a storage device information on an advertisement associated with the user, and providing the information associated with the advertisement to the user through the website in a response to a request from the user; and
receiving product information from the plurality of affiliate stores associated with the associated advertisements, and processing an integrated payment for the products or the services selected by the user, based on the product information received from the plurality of affiliate stores.

16. The media of claim 15, wherein the processing of the integrated payment comprises:
processing a transaction charge for the products or the services selected by the user using at least one of a checkout payment using a user identifier and a prepaid amount.

17. The system of claim 1, wherein the advertisement receiving unit, the advertisement providing unit, the information processing unit, and the integrated payment processing unit are integrated.
